(19) United States
(12) Patent Application Publication
(10) Pub. No.: US 2015/0290604 A1
(43) Pub. Date: Oct. 15, 2015

(54) ROTARY MIXER IN MULTI-LIQUID MIXING TYPE INJECTION MACHINE

(71) Applicant: Nippon Sosey Kogyo Co., Ltd., Minami-ku (JP)

(72) Inventor: Norihiro MORIKAWA, Nagoya (JP)

(21) Appl. No.: 14/508,470

(22) Filed: Oct. 7, 2014

(30) Foreign Application Priority Data
Apr. 11, 2014 (JP) 2014-082091

(51) Int. Cl. B01F 7/00; B01F 3/12

(52) U.S. Cl. CPC B01F 7/00891; B01F 3/1221; B01F 7/00433

(57) ABSTRACT

[Object] There are limitations on the mixing efficiency for chemicals with one rotor.

[Solving Means] A housing 1 which has a discharge nozzle 7 in its lower portion, one driving rotor 3 which is disposed in a space portion 2 in the housing 1, and driven rotors 4 and 4 which are installed side by side with the driving rotor 3 are provided, and a through hole 5 for a drive shaft S of a head part is formed in the upper portion of the housing 1, the upper end of the driving rotor 3 is coupled to the lower end of the drive shaft S, and inlets 6 and 6a for chemicals to the space portion 2 are formed in the upper lateral side of the housing 1, thereby it is possible to stir and mix a mixed liquid with the plurality of rotors 3, 4, and 4.

### TECHNICAL FIELD

The present invention relates to a rotary mixer in a multi-liquid mixing type injection machine which mixes two or more types of chemicals, and ejects it in cast molding, shape forming, coating, or the like.

### BACKGROUND ART

Conventionally, as a rotary mixer in such a multi-liquid mixing type injection machine, the rotary mixer is fixed to a head part in an injection machine main body, a rotor which makes a mixing action is internally mounted rotatably to the inside of a housing, the upper end portion of the rotor is attached to the lower end of a drive shaft on the head part side in the housing, thereby making the rotor rotatable, chemicals pass through the inside of the housing in which the rotor which makes chemicals flow together on the base end side of the housing and rotates is internally mounted, chemical mixing advances in that process, which causes a chemical reaction to start hardening, and a hardened resin is pushed out of the leading end of a nozzle equipped at the leading end of the housing, to be injected into a case, a molding machine, or the like (refer to, for example, Patent Document 1).

### PRIOR ART

### Patent Document

[Patent Document 1] Japanese Published Examined Patent Application No. 270665 (refer to Paragraph numbers [0003] to [0008])

### SUMMARY OF THE INVENTION

### Problems to be Solved by the Invention

However, because there is only the one rotor for mixing two chemicals in the above-described conventional technology, there is the problem to be solved, such that there are limitations on the mixing efficiency for chemicals.

### Means for Solving the Problem

In consideration of the problem that there are limitations on the mixing efficiency for chemicals with one rotor based on the above-described conventional technology, the present invention has a housing having a discharge nozzle at its lower portion, one driving rotor which is disposed in a space portion in the housing, and a driven rotor which is installed side by side with the driving rotor, and a through hole for a drive shaft of the head part is formed in the upper portion of the housing, the upper end of the driving rotor is coupled to the lower end of the drive shaft, and inlets for chemicals into the space portion are formed in the upper lateral side of the housing, thereby it is possible to stir and mix a mixed liquid with the plurality of rotors, which solves the above-described problem.

### Effects of the Invention

In summary, because the present invention has a housing having a discharge nozzle at its lower portion, one driving rotor which is disposed in a space portion in the housing, and a driven rotor which is installed side by side with the driving rotor, and a through hole of a drive shaft of the head part is formed in the upper portion of the housing, the upper end of the driving rotor is coupled to the lower end of the drive shaft, and inlets for chemicals into the space portion are formed in the upper lateral side of the housing, it is possible to stir and mix several types of chemicals in the housing with at least two or more rotors, and therefore, because it is possible to efficiently perform mixing, and efficiently advance hardening thereof, it is possible to manufacture a product made of an optimum material at a proper amount.

Further, because it is possible to reduce the internal volume of the housing according to the improvement of the mixing efficiency, it is possible to prevent liquid dripping, or reduce an amount of a mixed liquid which is extracted in the case of being mounted to a vacuum injection machine, for example.

Meanwhile, because the driven rotor is made rotatable in an opposite direction according to a rotation of the driving rotor by making the driven rotor be reverse winding at the same pitch as the driving rotor, and gearing the both, it is possible to efficiently perform mixing with a simple configuration, and moreover, because the driving rotor and the driven rotor are formed such that their clockwise helical elements and counterclockwise helical elements are alternately coupled in series so as to make the helical directions of the elements at the same stage of the driving rotor and the driven rotor opposite, dividing, turning, inverting actions are applied to a mixed liquid, which makes it possible to more efficiently perform mixing, and the like, which leads to enormous practical effects.

### BRIEF DESCRIPTION OF THE DRAWINGS

FIG. 1 is a plan view of a first embodiment of a rotary mixer according to the present invention.

FIG. 2 is a cross-sectional view taken along A to A in FIG. 1.

FIG. 3 is a cross-sectional view taken along B to B in FIG. 1.

FIG. 4 is a cross-sectional view taken along C to C in FIG. 2.

FIG. 5 is an exploded view of the rotary mixer of FIG. 1.

FIG. 6 are transverse sectional views showing states at each of rotational angles of elements at an odd number of stages and elements at an even number of stages in the rotor.

FIG. 7 is a vertical cross-sectional view of a second embodiment of the rotary mixer according to the present invention.

FIG. 8 is a vertical cross-sectional view of a third embodiment of the rotary mixer according to the present invention.

### EMBODIMENTS FOR CARRYING OUT THE INVENTION

A rotary mixer according to the present invention is fixed to a head part (now shown) in a two-liquid mixing type injection machine, and basically has a housing 1, one driving rotor 3 which is disposed in a space portion 2 in the housing 1, and a driven rotor 4 which is installed side by side with the driving rotor 3, and a through hole 5 for a drive shaft S of the head part (not shown) is formed in the upper portion of the housing 1, the upper end of the driving rotor 3 is coupled to the lower end of the drive shaft S, and inlets 6 and 6a for chemicals to the space portion 2 are formed in the upper lateral side of the housing 1, and a discharge nozzle 7 for a mixed liquid is provided in the lower portion of the housing 1.

### First Embodiment

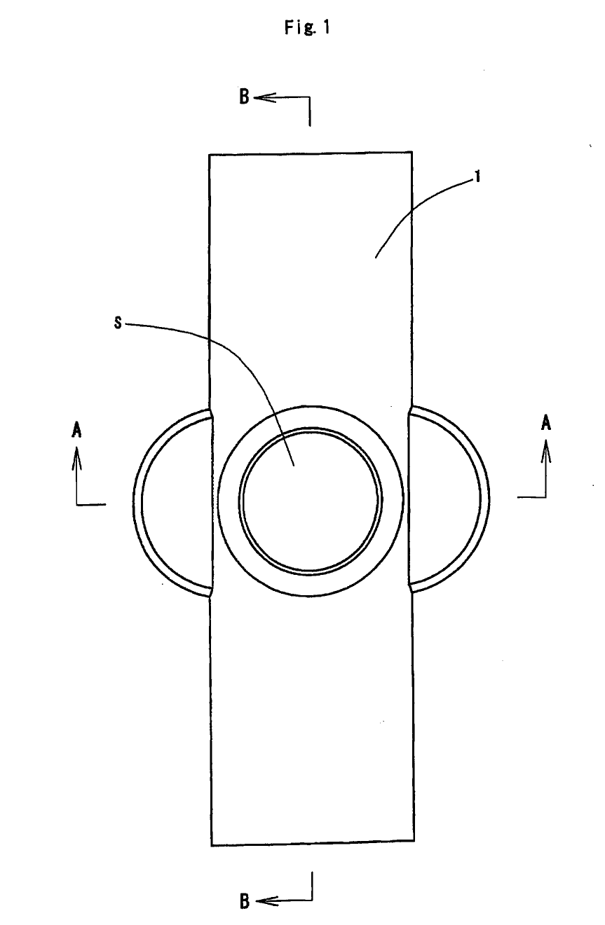

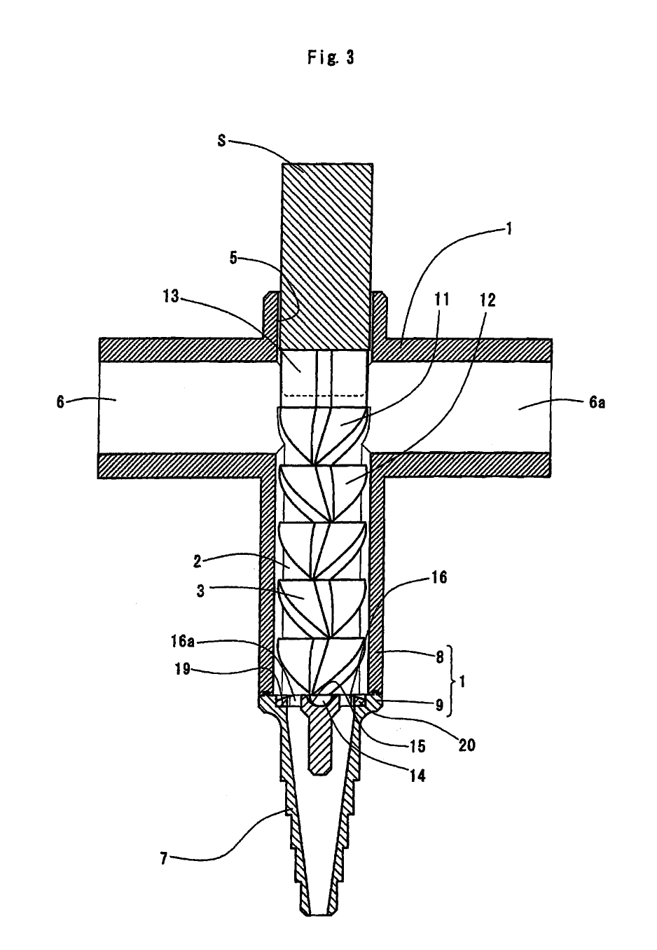

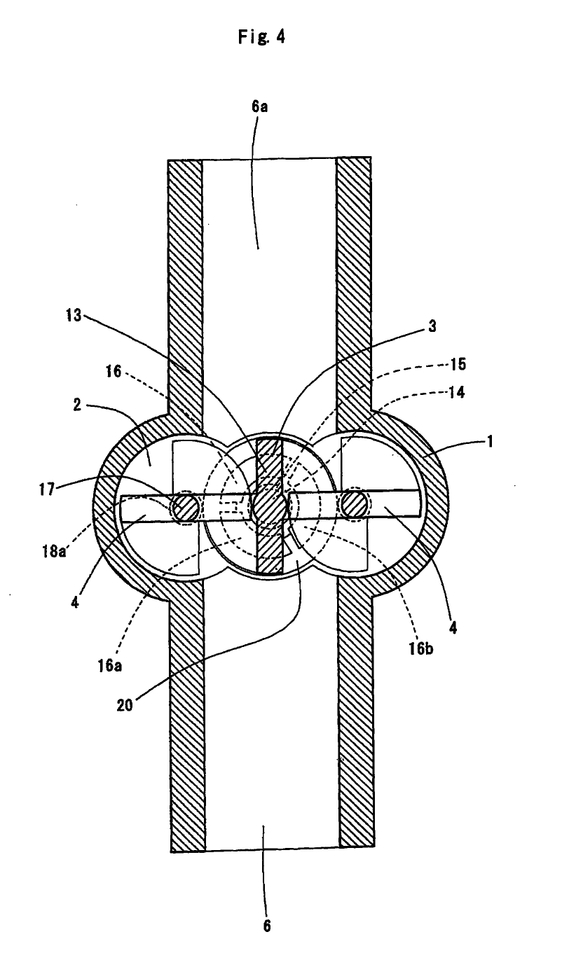

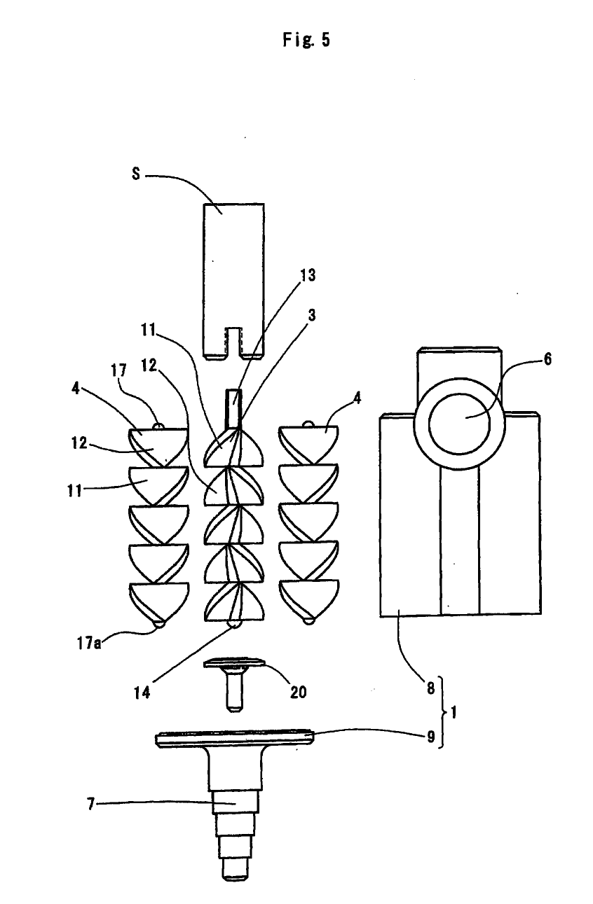

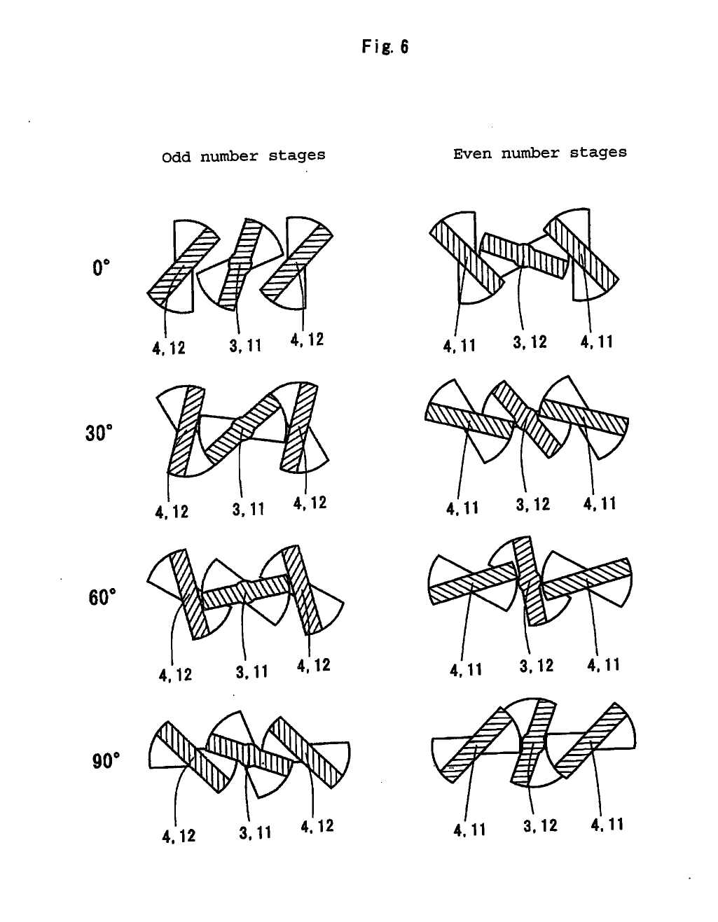

As a first embodiment of the rotary mixer according to the present invention, as shown in FIGS. 1 to 6, the rotary mixer has the housing 1, the one driving rotor 3 and two driven rotors 4 and 4 having a same diameter as that of the driving rotor 3, which are arranged in parallel, and the driving rotor 3 is disposed in the center, the driven rotors 4 and 4 are disposed on the both sides of the driving rotor 3, and the driven rotors 4 and 4 are made rotatable in an opposite direction according to a rotation of the driving rotor 3 by making the driven rotors 4 and 4 be reverse winding at a same pitch of the driving rotor 3, and gearing the both.

The housing 1 has a housing main body 8 which is open in its lower end, and a closing panel 9 for the opening portion in the lower end of the housing main body 8, and the discharge nozzle 7 is integrally formed in the center of the lower portion of the closing panel 9.

Further, the space portion 2 has a shape that three cylindrical spaces with a diameter which is slightly greater than the diameter of the rotors 3, 4 and 4 are arranged in parallel so as to be partially overlapped.

The driving rotor 3 has a shape that clockwise helical elements 11 and counterclockwise helical elements 12 are alternately coupled in series, and has a fixed portion 13 to the drive shaft S at its upper portion, and a semispherical protrusion 14 in the center of the lower portion, and the protrusion 14 is received at a bearing concave portion 15 formed in the interior surface of the housing 1 (the center of the top surface of the closing panel 9), and through holes 16, 16a, and . . . for a mixed liquid are provided so as to penetrate through the outer circumferential regions of the bearing concave portion 15 in the housing 1 (closing panel 9).

The driven rotors 4 and 4 have a shape that the counterclockwise helical elements 12 and the clockwise helical elements 11 are alternately coupled in series so as to make the helical directions of the elements at a same stage of the driving rotor 3 opposite, and have semispherical protrusions 17 and 17a in the centers of the upper and lower portions, and the protrusions 17 and 17a are received at bearing concave portions 18 and 18a formed in the interior surface of the housing 1 (the upper bottom surface in the concave portion of the housing main body 8 and the side portion of the through hole 5, and the side portion of the bearing concave portion 15 in the top surface of the closing panel 9).

In addition, a stepped hole 19 is formed in the center of the closing panel 9, and the bearing concave portion 15 is formed in the center of a bearing body 20 fitted into the stepped hole 19, the above-described through holes 16, 16a, and . . . are formed in the outer circumferential portion of the bearing concave portion 15 in the bearing body 20, and the lower bearing concave portions 18a are formed in the outer side portions of the stepped hole 19 in the top surface of the closing panel 9.

### Second Embodiment

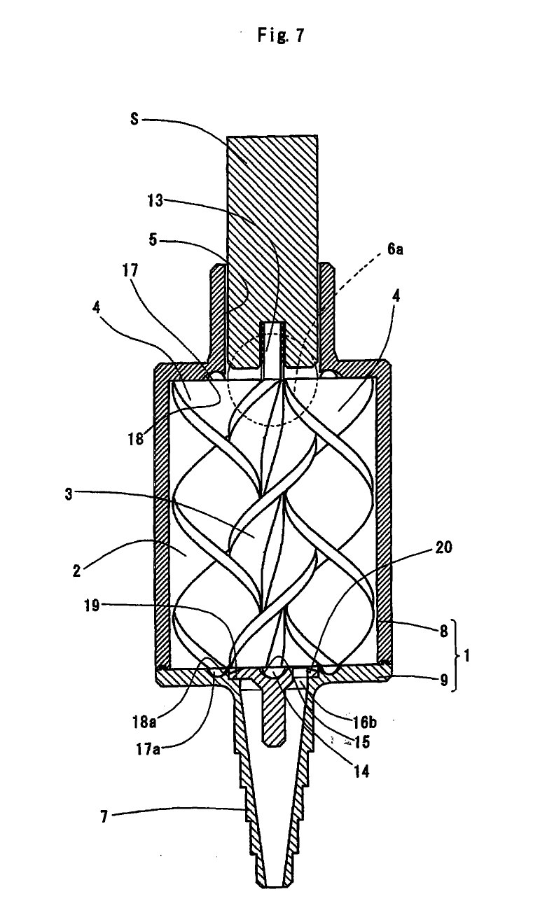

As a second embodiment of the rotary mixer according to the present invention, as shown in FIG. 7, in the same way as the first embodiment, the rotary mixer has the housing 1, and the one driving rotor 3 and the two driven rotors 4 and 4 which are arranged in parallel. Meanwhile, the driving rotor 3 and the two driven rotors 4 and 4 have continuous helical shapes which are not composed of a plurality of elements.

### Third Embodiment

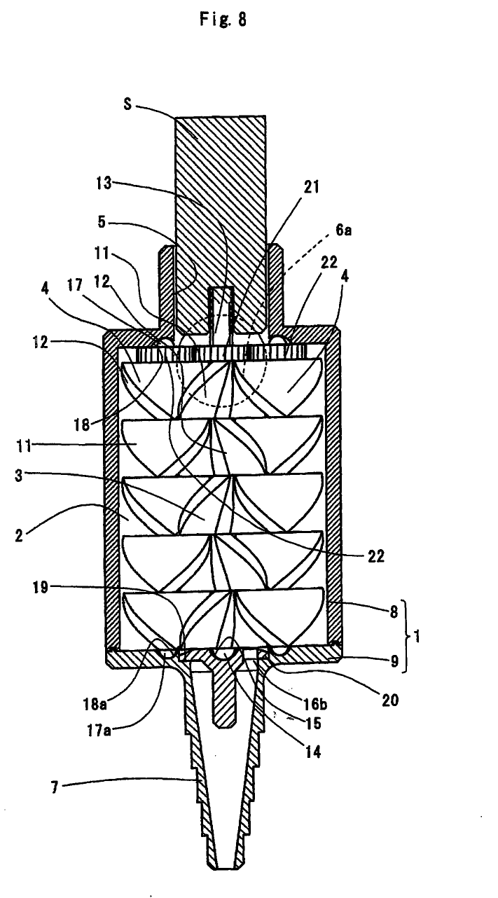

As a third embodiment of the rotary mixer according to the present invention, as shown in FIG. 8, in the same way as the first and second embodiments, the rotary mixer has the housing 1, and the one driving rotor 3 and the two driven rotors 4 and 4 which are arranged in parallel. Meanwhile, gears 21, 22, and 22 are provided in the upper portions of the driving rotor 3 and the driven rotors 4 and 4, and the driven rotors 4 and 4 are made rotatable in an opposite direction according to a rotation of the driving rotor 3 by gearing the gear 21 of the driving rotor 3 with the gears 22 and 22 of the driven rotors 4 and 4.

Next, the operation of the rotary mixer according to the present invention will be described.

When the driving rotor 3 is rotated, the driven rotors 4 and 4 rotate in the opposite direction according to this rotation, two types of chemicals which are pressure-fed into the space portion 2 by chemical pressure-feeding means (not shown) connected to the inlets 6 and 6a of the housing 1 flow together in the space portion 2, and the chemicals flowing together pass through the inside of the housing 1 in which the driving rotor 3 and the driven rotors 4 and 4 which are rotating are internally mounted, to flow toward the leading end in the housing 1 by continuing pressure-feeding of the chemicals by the chemical pressure-feeding means (not shown), and in that process, the two types of chemicals are efficiently mixed by the one driving rotor 3 and the two driven rotors 4 and 4, a total of 3 rotors, to efficiently advance hardening thereof, which causes a chemical reaction to start hardening, and a hardened resin is pushed out of the discharge nozzle 7 mounted to the leading end of the housing 1, to be used for a variety of uses.

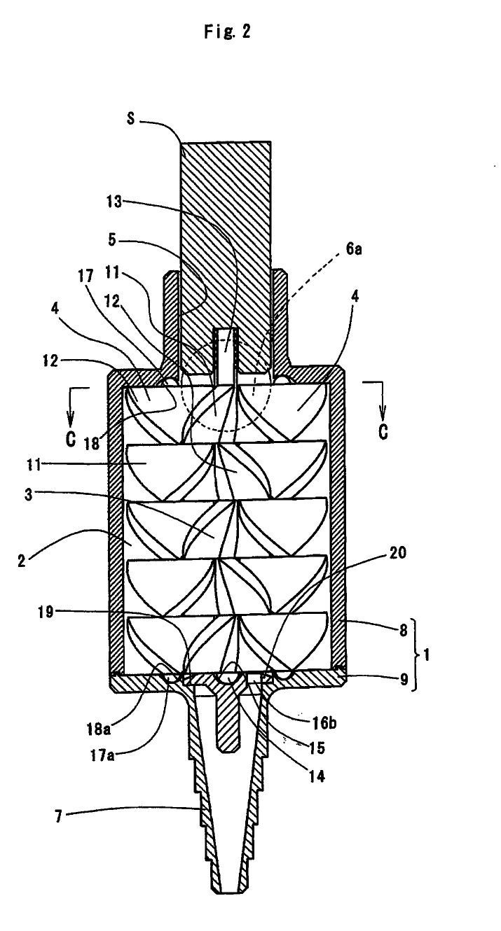

In particular, the driving rotor 3 and the driven rotors 4 and 4 shown in FIGS. 2 and 8 have a shape similar to internal elements of a so-called “static mixer,” and the stirring and mixing efficiency for a mixed liquid is improved by making this shape.

In addition, in the above-described first to third embodiments, the rotary mixer is a two-liquid mixing type in which the two inlets 6 and 6a are formed in the housing 1. Meanwhile, the rotary mixer may be a mixing type for three or more liquids, and it is necessary to form the inlets 6 and 6a_{—} as many as that number in the housing 1.

Further, the shapes of the driving rotor 3 and the driven rotors 4 and 4 are preferably formed into the helical shapes in the above-described embodiments 1 to 3. However, those are not limited to these shapes at all, that is, any shape which is capable of stirring and mixing a mixed liquid after flowing together may be used. Further, the two driven rotors 4 and 4 are provided in the above-described first to third embodiments. Meanwhile, the driven rotors may be one, or three or more.

Further, the interlocking mechanism of the driving rotor 3 and the driven rotors 4 and 4 is preferably a mechanism as in the above-described first and second embodiments. Meanwhile, in addition to the gear mechanism as in the above-described third embodiment, any mechanism which is structured to be capable of rotating the driven rotors 4 and 4 by utilizing the turning force of the driving rotor 3 may be used.

Further, it is assumed that the rotary mixer according to the present invention is used as an unwashable type which is detached to be discarded after the completion of an injection operation of hardening resin. Meanwhile, the rotary mixer may be used as a washable type washed to be reused.

### EXPLANATION OF SYMBOLS

1 Housing
2 Space portion
3 Driving rotor
4 Driven rotor
5 Through hole
6, 6a Inlets
7 Discharge nozzle
11 Clockwise helical element
12 Counterclockwise helical element
S Drive shaft

1. A rotary mixer which is fixed to a head part in a multi-liquid type injection machine comprising:
a housing having a discharge nozzle at a lower portion;
a driving rotor which is disposed in a space portion in the housing; and
a driven rotor which is installed side by side with the driving rotor, the rotary mixer wherein
a through hole for a drive shaft of the head part is formed in an upper portion of the housing,
an upper end of the driving rotor is coupled to a lower end of the drive shaft, and
inlets for chemicals into the space portion are formed in the upper lateral side of the housing.

2. The rotary mixer according to claim 1 wherein the driven rotor is made rotatable in an opposite direction according to a rotation of the driving rotor by making the driven rotor be reverse winding at a same pitch of the driving rotor, and gearing the both.

3. The rotary mixer according to claim 2 wherein the driving rotor and the driven rotor are formed such that clockwise helical elements and counterclockwise helical elements are alternately coupled in series so as to make the helical directions of the elements at a same stage of the driving rotor and the driven rotor opposite.
